(19) United States
(12) Patent Application Publication
(10) Pub. No.: US 2015/0116279 A1
(43) Pub. Date: Apr. 30, 2015

(54) ELECTRONIC APPARATUS AND COORDINATE CORRECTING METHOD

(71) Applicant: Kabushiki Kaisha Toshiba, Tokyo (JP)

(72) Inventors: Isao Ohba, Tokyo (JP); Toshiya Takano, Sagamihara-shi (JP); Tetsuya Fujii, Fussa-shi (JP)

(21) Appl. No.: 14/338,131

(22) Filed: Jul. 22, 2014

(30) Foreign Application Priority Data
Oct. 28, 2013 (JP) 2013-223144

(51) Int. Cl. G06F 3/041; G06F 3/038; G06F 3/0354

(52) U.S. Cl. CPC G06F 3/0418; G06F 3/03545; G06F 3/038
USPC 345/178

(57) ABSTRACT

According to one embodiment, an electronic apparatus includes a first detector, a second detector and a processor. The first detector is configured to detect a first position on a detection surface. The second detector is configured to detect a second position indicated by an indicator on the detection surface. The processor is configured to determine a first orientation of inclination of the indicator based on first coordinates of the first position on the detection surface and second coordinates of the second position on the detection surface, and to correct the second coordinates based on the first orientation of inclination.

### CROSS-REFERENCE TO RELATED APPLICATIONS

This application is based upon and claims the benefit of priority from Japanese Patent Application No. 2013-223144, filed Oct. 28, 2013, the entire contents of which are incorporated herein by reference.

### FIELD

Embodiments described herein relate generally to an electronic apparatus and a coordinate correcting method.

### BACKGROUND

Electronic apparatuses with a device configured to detect the position indicated on a detection surface by a user using, for example, a pen-type indicator are available. Such devices are called, for example, digitizers.

For instance, the indicator incorporates a magnetic field source, and the digitizer incorporates a plurality of loop coils for detecting the magnetic field of the magnetic field source. The digitizer calculates the coordinates of the position indicated by the indicator, based on the detection results of the loop coils.

When the indicator inclines relative to the detection surface, the coordinates calculated based on the magnetic field of each loop coil may deviate from the position indicated by the tip of the indicator.

It is an object of the embodiments to provide an electronic apparatus capable of accurate position inputting even if the indicator is used inclined, and a coordinate correcting method for use in the apparatus.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view of the appearance of an electronic apparatus according to an embodiment;

FIG. 2 is a perspective view of a display unit incorporated in the electronic apparatus;

FIG. 3 is a view for explaining the procedure of position detection performed by a digitizer incorporated in the electronic apparatus;

FIG. 4 is a block diagram showing the elements for realizing correction of the position detected by the digitizer;

FIG. 5 is a view for explaining the bearing angle of the indicator used for inputting by the digitizer;

FIG. 6 shows measurement results of the coordinates of the first and second positions;

FIG. 7 shows the variation in bearing angle calculated based on the measurement results shown in FIG. 6;

FIG. 8 is a view for explaining the elevation angle of the indicator used for the input of the digitizer;

FIG. 9 is a flowchart of the operation of the electronic apparatus;

FIG. 10 is a flowchart of position correction processing in FIG. 9;

FIG. 11 is a view showing the positional relationship between first, second and correction positions; and

FIG. 12 is a flowchart of a modification of the embodiment.

### DETAILED DESCRIPTION

Various embodiments will be described hereinafter with reference to the accompanying drawings.

In the description below, like reference numbers denote like elements, and duplicate explanations will be omitted.

In general, according to one embodiment, an electronic apparatus includes a first detector, a second detector and a processor. The first detector is configured to detect a first position on a detection surface. The second detector is configured to detect a second position indicated by an indicator on the detection surface. The processor is configured to determine a first orientation of inclination of the indicator based on first coordinates of the first position on the detection surface and second coordinates of the second position on the detection surface, and to correct the second coordinates based on the first orientation of inclination.

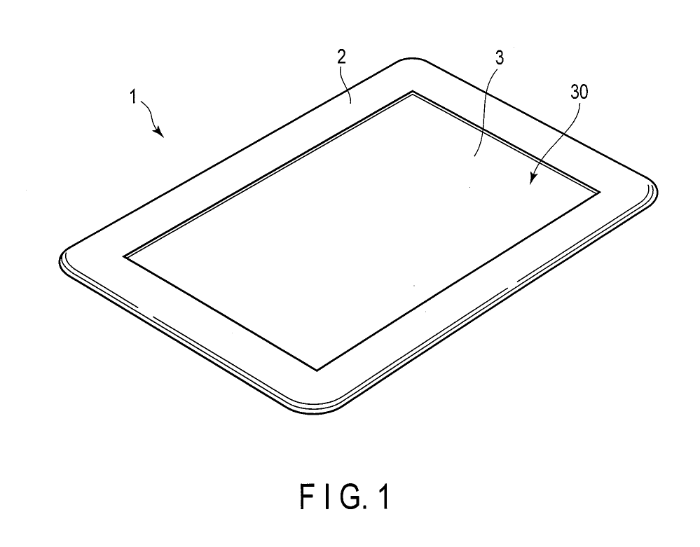

FIG. 1 is a perspective view of the appearance of an electronic apparatus 1 according to an embodiment. The electronic apparatus 1 is a tablet terminal comprising a flat casing 2 and a display unit 3 received therein. One surface of the display unit 3 exposed through the casing 2 serves as a display surface for still and video images, and also serves as a detection surface 30 for detecting user operations.

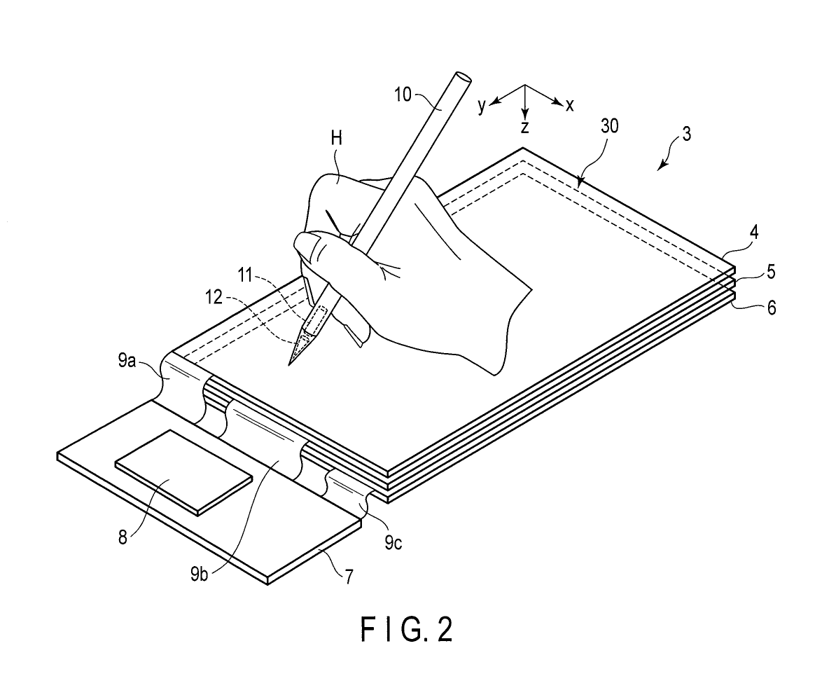

FIG. 2 is a perspective view for explaining the structure of the display unit 3. The display unit 3 includes a touch panel 4 as a first detector, a liquid crystal display (LCD) panel 5, and a sensor board 6 as a second detector. The touch panel 4, the LCD panel 5 and the sensor board 6 are formed rectangular and flat to have the same size, and are stacked in this order. Namely, the detection surface 30 is also rectangular. In the embodiment, an X axis is defined as the line parallel to the short side of the detection surface 30, and a Y axis is defined as the line parallel to the long side of the detection surface 30. Further, a Z axis is defined as the line perpendicular to the X and Y axes.

When the touch panel 4 touches part of the body of the user, such as a hand H or a finger, it generates a detection signal corresponding to the contact position. As the touch panel 4, a touch panel of, for example, an electrostatic capacitance type can be used. The user's contact position on the detection surface 30 will hereinafter be refereed to as a “first position P1.”

The LCD panel 5 includes a backlight unit with a light source and a light guiding plate, a liquid crystal module for controlling the passing of light emitted from the backlight unit, and a plurality of optical sheets, such as a prism sheet and a deflection sheet.

The sensor board 6 outputs a detection signal corresponding to the position on the detection surface 30 indicated by the tip of the indicator 10. The position on the detection surface 30 indicated by the tip of the indicator 10 will hereinafter be referred to as a “second position P2.”

The display unit 3 further includes a substrate 7, a signal processor 8, and flexible cables 9a, 9b and 9c. The substrate 7 is mounted with, for example, a signal processor 8. The flexible cable 9a electrically connects the substrate 7 and the touch panel 4. The flexible cable 9b electrically connects the LCD panel 5 and the substrate 7. The flexible cable 9c electrically connects the sensor board 6 and the substrate 7.

The signal processor 8 drives the touch panel 4, the LCD panel 5 and the sensor board 6, and processes detection signals output from the touch panel 4 and the sensor board 6. For instance, the signal processor 8 calculates the coordinates of the first position P1 based on the detection signal output from the touch panel 4. Hereinafter, the X coordinate of the first position P1 will be referred to “Xh,” and the Y coordinate of the first position P1 be referred to “Yh.”

Further, the signal processor 8 calculates the coordinates of the second position P2 based on the detection signal output from the sensor board 6. Hereinafter, the X coordinate of the second position P2 will be referred to “Xp,” and the Y coordinate of the second position P2 be referred to “Yp.”

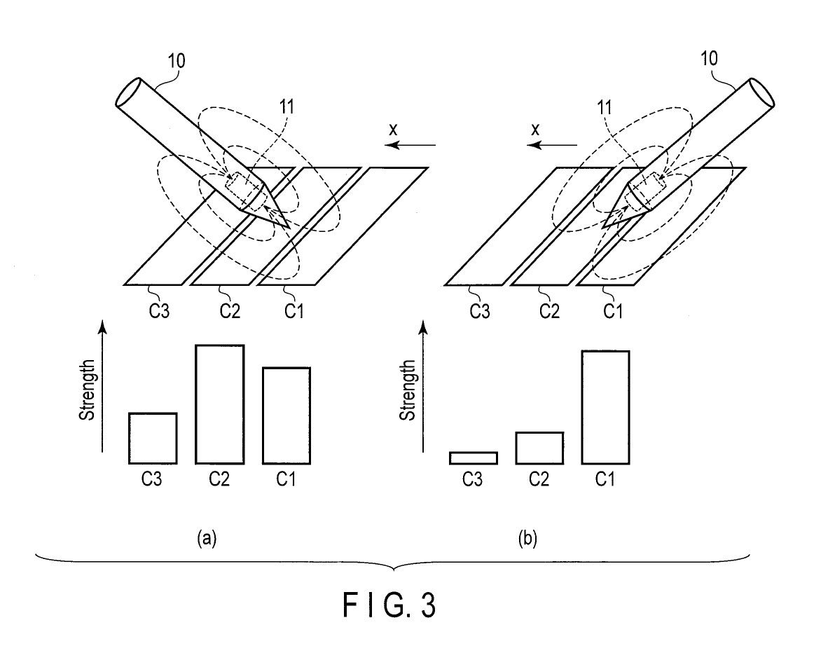

In the embodiment, the sensor board 6 constitutes a digitizer of the electromagnetic induction type, along with, for example, the signal processor 8. Namely, the sensor board 6 includes a plurality of loop coils C (see FIG. 3) arranged along the X axis direction, and a plurality of loop coils C arranged along the Y axis direction.

The indicator 10 has a shape like a pen. The indicator 10 contains a resonance circuit 11 functioning as a magnetic field source, and a pen pressure sensor 12. The resonance circuit 11 includes a coil, a capacitor, etc. The pen pressure sensor 12 detects the pressure applied to the pen tip of the indicator 10.

Referring now to (a) and (b) of FIG. 3, a description will be given of the procedure of position detection by the above-constructed digitizer. For facilitating the description, (a) and (b) of FIG. 3 only show three loop coils C (C1, C2 and C3) arranged along the X axis direction and included in a number of loop coils incorporated in the sensor board 6. Further, the lower portions of (a) and (b) of FIG. 3 show, in the form of graphs, magnetic field detection results associated with the loop coils C.

When a current has been passed from the substrate 7 to each loop coil C of the sensor board 6 via the flexible cable 9c, each loop coil C generates a magnetic field spreading all over the detection surface 30. Upon receiving the magnetic field, induction voltage occurs in the resonance circuit 11 to accumulate energy therein.

After the supply of current to each loop coil C is stopped, the energy accumulated in the resonance circuit 11 causes the resonance circuit 11 to generate a magnetic field as indicated by the broken lines in (a) and (b) of FIG. 3. By this magnetic field, induction voltages occur in the loop coils C positioned near the indicator 10. The induction voltages occurring in the loop coils C are amplified by, for example, an amplification circuit incorporated in the substrate 7, and are input as detection signals to the signal processor 8. In general, these detection signals are distributed such that the signal corresponding to the loop coil C just below the resonance circuit 11 has a maximum level. In the example shown in (a) of FIG. 3, the loop coil C2 just below the resonance generates a detection signal of a maximum level. Based on the detection signals from the loop coils C arranged along the X axis, and a predetermined calculation formula, the signal processor 8 calculates the coordinate Xp of the second position P2 indicated by the tip of the indicator 10.

The signal processor 8 also calculates the coordinate Yp of the second position P2, using the loop coils C arranged along the Y axis direction and the same method as that used for calculating the coordinate Xp. The resonance circuit 11 is configured to vary in resonance frequency in accordance with the pen pressure detected by the pen pressure sensor 12. The signal processor 8 determines the resonance frequency based on variations in the detection signals of the loop coils C, and generates pen pressure data indicating the magnitude of pen pressure, based on the determined resonance frequency.

When calculating the coordinates (Xp, Yp) of the second position P2 using the above method, a deviation may well occur between the position actually indicated by the tip of the indicator 10 and the coordinates calculated as the above, because of inclination of the indicator 10. This type of deviation is conspicuous in particular when the tip of the indicator 10 is positioned at an end of the detection surface 30.

Referring to (b) of FIG. 3, the occurrence of the above-mentioned deviation will be described. Assume here that the loop coil C1 is positioned at an end along the X axis direction, the resonance circuit 11 is positioned just above the loop coil C1, and the indicator 10 is outwardly inclined with respect to the detection surface 30. In this case, the detection signal of the loop coil C1 just below the resonance circuit 11 has a maximum level. In (b) of FIG. 3, although the magnetic field of the resonance circuit 11 extends to the right side of the loop coil C1 (i.e., to the outside of the detection surface 30), the outside cannot be detected by the sensor board 6. Accordingly, in (b) of FIG. 3, the magnetic field of the resonance circuit 11 cannot accurately be detected, whereby a deviation will inevitably occur between the calculated coordinates (Xp, Yp) and the coordinates indicated by the tip of the indicator 10.

To prevent the above deviation, the sensor board 6 may additionally employ loop coils C positioned outside the surface (detection surface 30) of the LCD panel 5. In this case, even when the indicator 10 indicates an end of the detection surface 30, the magnetic field of the resonance circuit 11 can be detected. However, the electronic apparatus 1 will inevitably be enlarged by the added loop coils C.

Further, even when the tip of the indicator 10 is positioned at an end of the detection surface 30, the magnetic field of the resonance circuit 11 can be relatively accurately detected by the loop coils C1 to C3, if the indicator 10 is inclined inwardly with respect to the detection surface 30 as shown in (a) of FIG. 3.

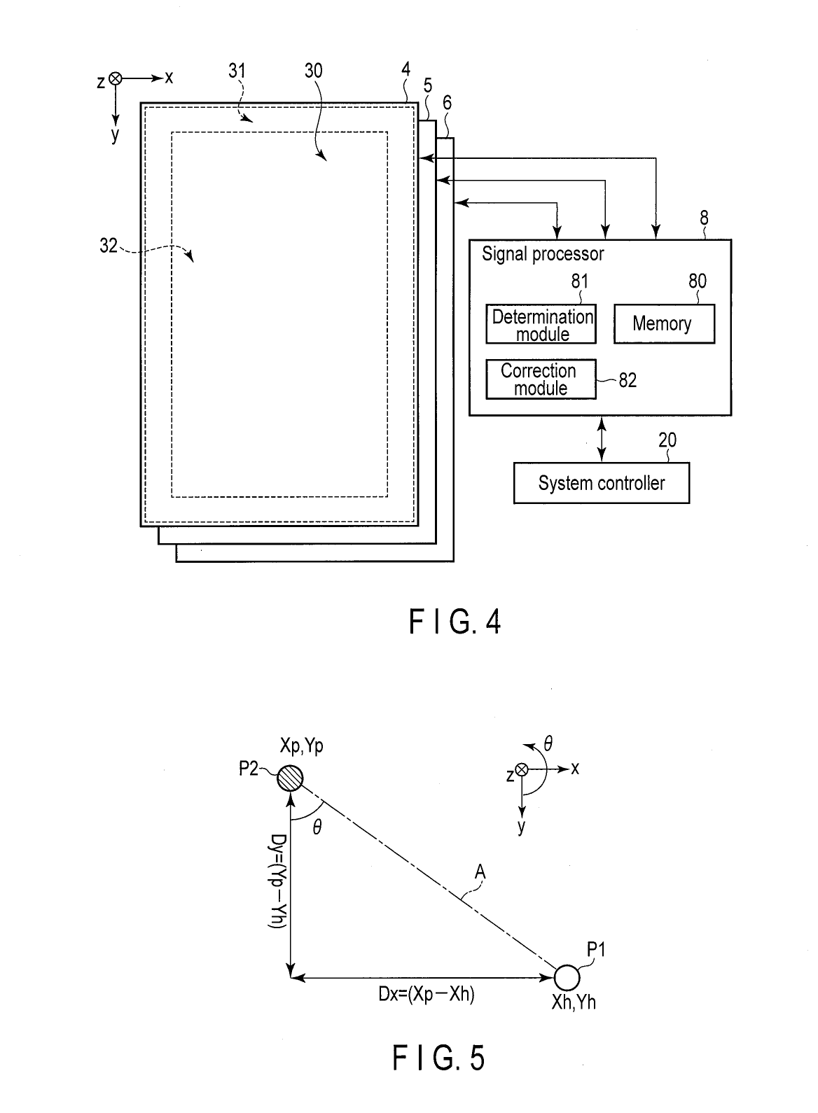

The electronic apparatus 1 has a function of correcting the above-mentioned deviation. FIG. 4 is a block diagram showing the elements for realizing the correction function.

In the embodiment, an outer peripheral region 31 and a central region 32 are defined. The outer peripheral region 31 is where the above-described coordinate deviation will easily occur, and is defined, for example, at predetermined distances from the four sides of the detection surface 30. The central region 32 is obtained by excluding the outer peripheral region 31 from the detection surface 30. The boundary between the outer peripheral region 31 and the central region 32 may be determined by estimating, for example, the degree of the above-mentioned deviation.

The electronic apparatus 1 includes, in the casing 2, a system controller 20 configured to control each element of the apparatus 1. The signal processor 8 is connected to the system controller 20 via, for example, the substrate 7.

The signal processor 8 includes a memory 80. The memory 80 is formed of a read only memory (ROM) and a random access memory (RAM), and stores, for example, computer programs to be executed by the signal processor 8. The memory 80 is also used as a work area by the signal processor 8. The signal processor 8 realizes various functions associated with the display unit 3 by executing the computer programs stored in the memory 80. For instance, when performing the above-described deviation correction, the signal processor 8 realizes functions as a determination module 81 and a correction module 82.

The determination module 81 determines the inclination orientation of the indicator 10 based on the coordinates (Xh, Yh) of the first position P1 and the coordinates (Xp, Yp) of the second position P2.

When the coordinates (Xp, Yp) are needed to be corrected, the correction module 82 corrects the coordinates (Xp, Yp) based on the inclination orientation determined by the determination module 81. The coordinates corrected by the correction module 82 will hereinafter be referred to as corrected coordinates (Xp′, Yp′), and the position on the detection surface 30 indicated by the corrected coordinates (Xp′, Yp′) will hereinafter be referred to as a corrected position P2′.

While the input by the digitizer is kept on, the signal processor 8 periodically calculates the coordinates (Xp, Yp) and outputs them to the system controller 20. When the coordinates (Xp, Yp) have been corrected, the signal processor 8 outputs the corrected coordinates (Xp′, Yp′) to the system controller 20, instead of the coordinates (Xp, Yp).

The system controller 20 includes a processor such as a central processing unit (CPU), and memories such as a ROM and a RAM. The processor realizes the operating system (OS) of the electronic apparatus 1 and various applications by executing the computer programs stored in, for example, the memories. The coordinates (Xp, Yp) and the corrected coordinates (Xp′, Yp′) sent from the signal processor 8 to the system controller 20 are used during processing by the above-mentioned OS or applications.

In the embodiment, the inclination orientation is expressed using a bearing angle θ and an elevation angle ρ. The bearing angle θ represents the inclination of the indicator 10 with respect to a predetermined reference orientation in the plane parallel to the detection surface 30. The elevation angle ρ represents the inclination of the indicator 10 with respect to the detection surface 30.

Referring now to FIG. 5 showing a positional relationship model, a method of determining the bearing angle θ will be described. This model shows the relationship between the first and second positions P1 and P2 assumed when the detection surface 30 is seen along the Z axis. The coordinates (Xh, Yh) of the first position P1 used for calculating the bearing angle θ can be set to an arbitrary one of the pairs of coordinates (Xh, Yh) detected based on the signals from the touch panel 4. Alternatively, the coordinates (Xh, Yh) of the first position P1 may be set to the center of the contact area of a user's hand on the detection surface 30 estimated from a pair of or pairs of coordinates (Xh, Yh).

In the embodiment, it is assumed that the axis A of the indicator 10 exists on the line connecting the first and second positions P1 and P2. Further, the angle counterclockwise formed from a line X=Xp parallel to the Y axis, to the axis A is defined as the bearing angle θ (0≦θ≦2π). Namely, the above-mentioned reference orientation in the embodiment is the Y axis orientation.

In the example of FIG. 5, the distance Dx along the X axis between the first and second positions P1 and P2 is (Xp−Xh), and hence assumes a negative value. Similarly, the distance Dy along the Y axis between the first and second positions P1 and P2 is (Yp−Yh), and hence assumes a negative value. In the quadrant where both (Xp−Xh) and (Yp−Yh) assume negative values, the bearing angle θ can be calculated using the following equation:

θ=tan⁻¹((Xp−Xh)/(Yp−Yh)) (1)

Also in the quadrants where (Xp−Xh) and (Yp−Yh) assume negative and positive values, respectively, where both (Xp−Xh) and (Yp−Yh) assume positive values, and where (Xp−Xh) and (Yp−Yh) assume positive and negative values, respectively, the bearing angle θ can be calculated using the angle obtained in the right-hand side of the above equation (1).

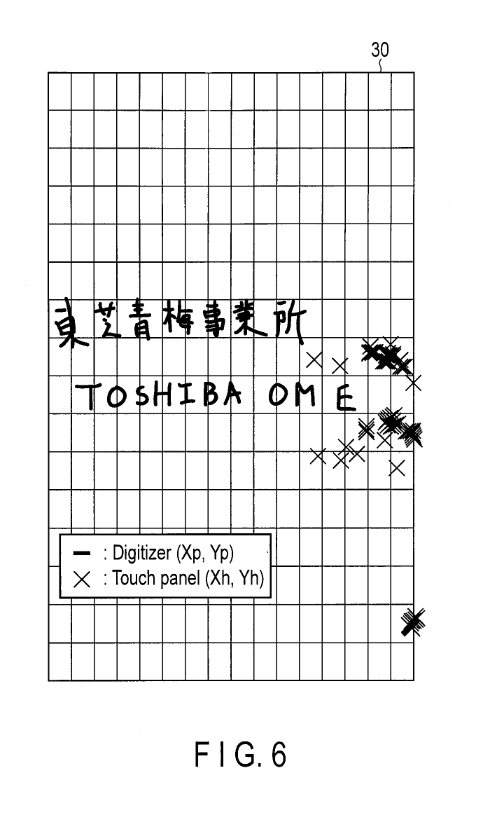

FIG. 6 shows the measurement results of the first position P1 coordinates (Xh, Yh) and the second position P2 coordinates (Xp, Yp). In this figure, a grid pattern is arranged on the detection surface 30 to enhance the visibility of the measurement results. The examinee who wrote a sequence of characters using the indicator 10 is a right-handed man.

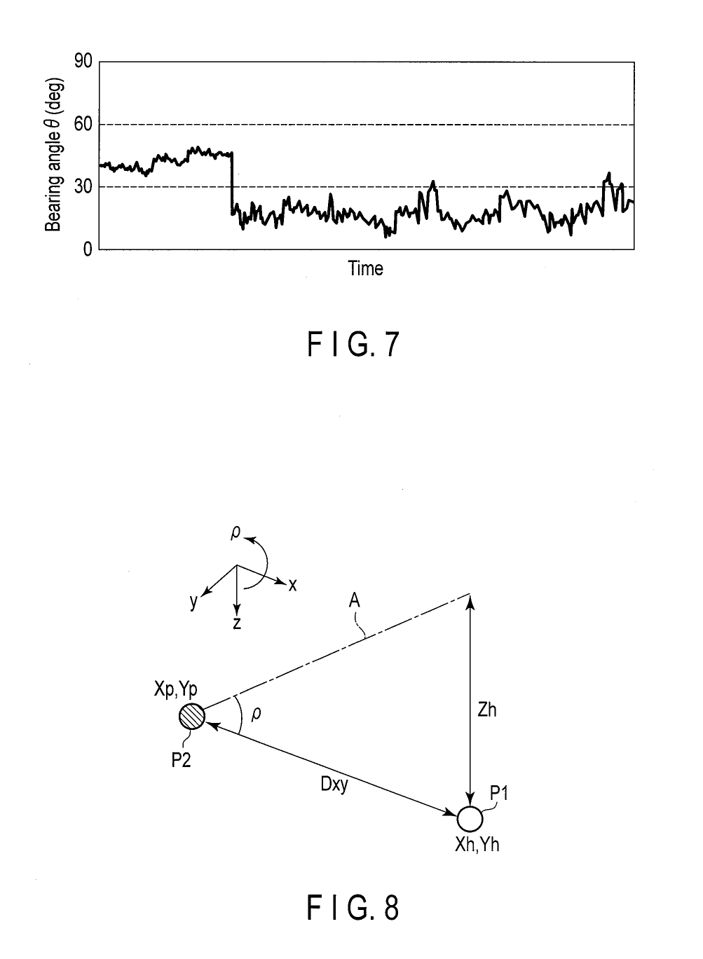

FIG. 7 shows bearing angles θ calculated based on the measurement results of FIG. 6. The characters were written from the left to the right on the detection surface 30. At the start of writing, the first and second positions P1 and P2 were away from each other and the bearing angle θ fell within a range of 30 to 60 degrees. When writing advanced, the first and second positions P1 and P2 were close to each other and the bearing angle θ fell within a range of 0 to 30 degrees.

Referring then to FIG. 8, a description will be given of a method of determining the elevation angle ρ. The model of FIG. 8 shows the relationship between the first and second positions P1 and P2 assumed when the detection surface 30 is seen obliquely.

Assuming that the distance between the first and second positions P1 and P2 is Dxy, and that the axis A of the indicator 10 exists at the distance Zh from the first position P1 along the direction opposite to Z axis direction, the elevation angle ρ is given by the following equation:

ρ=tan⁻¹(Zh/Dxy) (2)

where the distance Dxy can be calculated as follows:

Dxy=((Xp−Xh)²+(Yp−Yh)²)^{1/2} (3)

As is evident from the above equations (2) and (3), 0≦ρ<π/2.

Zh corresponds to the height of the user's hand grasping the indicator 10 from the detection surface 30. Zh can be set as a predetermined fixed value. Further, Zh may be set dynamically based on the detection result of the touch panel 4. For instance, Zh may be determined, based on the contact area of the user's hand on the detection surface 30 estimated from the detection result of the touch panel 4.

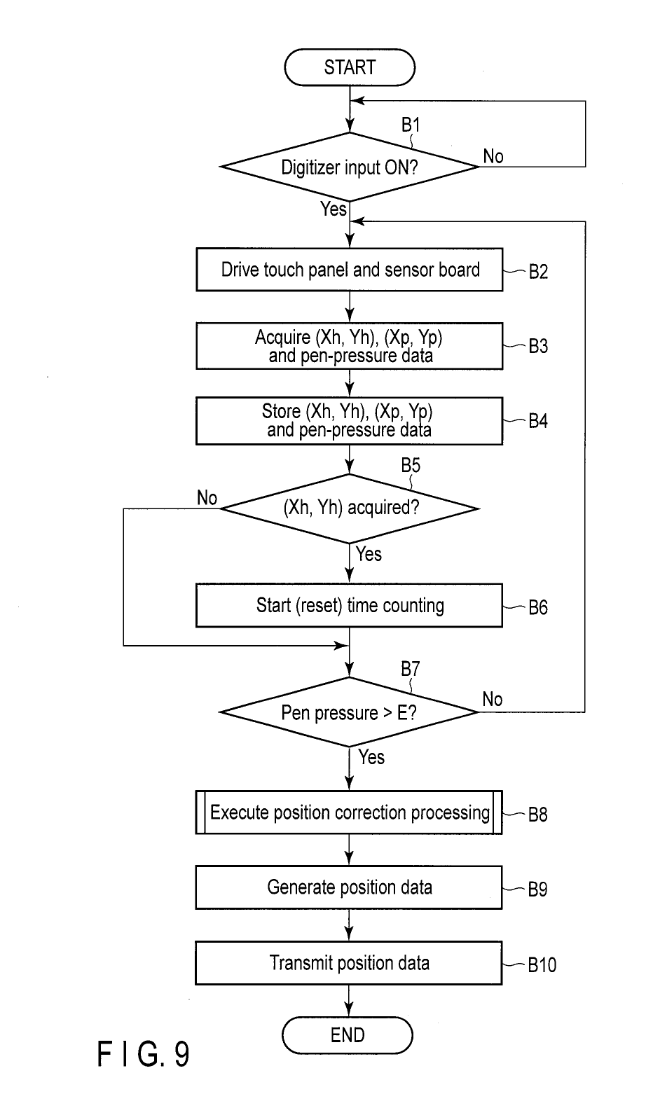

Referring to FIGS. 9 and 10, a description will be given of a specific operation of the electronic apparatus 1.

When the electronic apparatus 1 is activated, the signal processor 8 repeatedly executes the processing shown in the flowchart of FIG. 9. In this flowchart, firstly, the signal processor 8 is kept in a standby state until the input function using the digitizer is started by the system controller 20 (block B1). When the input function using the digitizer becomes necessary during the operation of the OS or application, the system controller 20 supplies the signal processor 8 with a command for instructing the turn-on of the digitizer.

Upon receiving the command (Yes in block B1), the signal processor 8 drives the touch panel 4 and the sensor board 6 (block B2). Further, based on the signals output from the touch panel 4 and the sensor board 6, the signal processor 8 acquires data on the coordinates (Xh, Yh) of the first position P1 in which the user's hand grasping the indicator 10 touches the detection surface 30, on the coordinates (Xp, Yp) of the second position P2 indicated by the tip of the indicator 10, and on pen-pressure data indicating the pen pressure detected by the pen-pressure sensor 12 (block B3).

The signal processor 8 stores, in the memory 80, the coordinate data (Xh, Yh) and (Xp, Yp) and pen-pressure data (block B4). When the coordinate data (Xh, Yh) and (Xp, Yp) and pen-pressure data are already stored in the memory 80, the signal processor 8 updates them by replacing them with the data acquired in block B3.

When the user keeps their hand away from the detection surface 30, the signal processor 8 cannot acquire the coordinate data (Xh, Yh) in block B3. In this case, in block B4, the signal processor 8 maintains the coordinate data (Xh, Yh) that was stored in the memory 80 in block B4 of a previous loop.

After block B4, the signal processor 8 determines whether the coordinate data (Xh, Yh) was acquired in block B3 of the current loop (block B5).

If it is determined that the coordinate data (Xh, Yh) was acquired (Yes in block B5), the signal processor 8 starts time counting using a timer (not shown) (block B6). The timer is, for example, a software timer realized in the signal processor 8. If the timer is already performing time counting, the signal processor 8 resets the timer in block B6.

After block B6, the signal processor 8 determines whether the pen pressure indicated by the pen-pressure data stored in the memory 80 in block B4 exceeds a predetermined threshold E (block B7). The threshold E discriminates the pen pressure obtained when the tip of the indicator 10 touches the detection surface 30, from that obtained when it does not touch the detection surface 30.

If it is determined that the pen pressure indicated by the pen-pressure data is equal to or less than the threshold E (No in block B7), i.e., if the tip of the indicator 10 does not touch the detection surface 30, the processing of the signal processor 8 is returned to block B2.

If it is determined in block B5 that the coordinate data (Xh, Yh) was not acquired in block B3 immediately before block B5 (No in block B5), the signal processor 8 skips block B6 and executes block B7. Namely, the timer continues time counting until new coordinate data (Xh, Yh) is obtained. The time counting by the timer is continued even after the processing indicated by the flowchart of FIG. 9 is once completed.

If it is determined in block B7 that the pen pressure indicated by the pen-pressure data exceeds the threshold E (Yes in block B7), the signal processor 8 executes position correction processing (block B8).

FIG. 10 is a flowchart showing in detail the position correction processing in block B8. The processing in blocks B82 and B83 is realized when the signal processor 8 functions as the determination module 81. The other processing is realized when the signal processor 8 functions as the correction module 82.

In this flowchart, firstly, the signal processor 8 determines whether the time counted by the timer exceeds predetermined time Te (block B81). The time Te is a threshold for determining whether the coordinates (Xp, Yp) should be corrected, and is set to, for example, approx. 30 seconds.

If it is determined that the time Te is not exceeded (No in block B81), the signal processor 8 calculates the bearing angle θ, using the method that has been described referring to FIG. 5, based on the coordinates (Xp, Yp) and (Xh, Yh) stored in the memory 80 (block B82).

The signal processor 8 also calculates the elevation angle ρ, using the method described referring to FIG. 8, based on the coordinates (Xp, Yp) and (Xh, Yh) stored in the memory 80 (block B83).

After block B83, the signal processor 8 determines whether the coordinates (Xp, Yp) stored in the memory 80 belong to the outer peripheral region 31 (block B84).

If it is determined that the coordinates (Xp, Yp) stored in the memory 80 belong to the outer peripheral region 31 (Yes in block B84), the signal processor 8 determines whether the indicator 10 is inclined in an orientation in which correction is needed (block B85). As described above with reference to FIG. 3, even when the tip of the indicator 10 is positioned at an end (outer peripheral region 31) of the detection surface 30, if the indicator 10 is inclined inwardly with respect to the detection surface 30, the magnetic field of the resonance circuit 11 can be relatively accurately detected by the loop coils C. Accordingly, the position actually indicated by the tip of the indicator 10 is little deviated from the coordinates (Xp, Yp). In view of this, the signal processor 8 determines that correction is needed if the indicator 10 is inclined outwardly with respect to the detection surface 30, and determines that no correction is needed if the indicator 10 is inclined inwardly with respect to the detection surface 30.

Such determination can be performed using the coordinates (Xp, Yp) and (Xh, Yh) stored in the memory 80. For instance, when the coordinates (Xp, Yp) indicate a position close to the right side of the detection surface 30 shown in FIG. 4, if the coordinate (Xp−Xh) is negative, it is determined that the indicator 10 is inclined outwardly with respect to the detection surface 30. In contrast, if the coordinate (Xp−Xh) is positive, it is determined that the indicator 10 is inclined inwardly with respect to the detection surface 30. Further, when the coordinates (Xp, Yp) indicate a position close to the left side of the detection surface 30 shown in FIG. 4, if the coordinate (Xp−Xh) is positive, it is determined that the indicator 10 is inclined outwardly with respect to the detection surface 30. In contrast, if the coordinate (Xp−Xh) is negative, it is determined that the indicator 10 is inclined inwardly with respect to the detection surface 30. Also when the coordinates (Xp, Yp) indicate a position close to the upper or lower side of the detection surface 30, similar determination is possible depending upon whether the coordinate (Yp−Yh) is positive or negative.

If it is determined in block B85 that correction is needed (Yes in block B85), the signal processor 8 generates correction data (Xa, Ya), based on the bearing angle θ calculated in block B82 and the elevation angle ρ calculated in block B83 (block B86). The signal processor 8 stores the generated correction data (Xa, Ya) in the memory 80. The correction data Xa is data for correcting the coordinate Xp, and correction data Ya is data for correcting the coordinate Yp.

After block B86, the signal processor 8 corrects the coordinates (Xp, Yp) stored in the memory 80, using the correction data (Xa, Ya), thereby generating corrected coordinates (Xp′, Yp′) (block B87). The signal processor 8 stores the corrected coordinates (Xp′, Yp′) in the memory 80. Block B87 is the termination of the position correction processing by the signal processor 8.

If it is determined in block B81 that the time Te is exceeded (Yes in block B81), accuracy of correction calculation may be degraded. Therefore, in this case, the signal processor 8 finishes the position correction processing without executing block B82 et seq.

If it is determined in block B84 that the coordinates (Xp, Yp) do not belong to the outer peripheral region 31 (No in block B84), the signal processor 8 finishes the position correction processing without executing block B85 et seq.

If it is determined in block B85 that no correction is needed (Yes in block B85), the signal processor 8 finishes the position correction processing without executing block B86 et seq.

A method example of generating correction data (Xa, Ya) in block B86 will be described. For instance, the signal processor 8 substitutes the bearing angle θ and elevation angle ρ calculated in blocks B82 and B83 into a predetermined function FX (θ, ρ), thereby generating the correction data Xa. Similarly, the signal processor 8 substitutes the bearing angle θ and elevation angle ρ calculated in blocks B82 and B83 into a predetermined function FY (θ, ρ), thereby generating the correction data Ya.

The functions FX (θ, ρ) and FY (θ, ρ) are defined, for example, based on experimentally estimated deviations between the coordinates (Xp, Yp) and the position indicated by the tip of the indicator 10, so that appropriate correction data (Xa, Ya) can be acquired. In general, there are variations between electronic apparatuses of the same type in the degree of deviation and in the orientation in which deviation occurs. In light of this, it is preferable to set the functions FX (θ, ρ) and FY (θ, ρ) for each electronic apparatus 1.

Further, different functions FX (θ, ρ) and FY (θ, ρ) may be set for the respective four sides of the detection surface 30. In this case, the correction data (Xa, Ya) is calculated using the functions FX (θ, ρ) and FY (θ, ρ) associated with the side closest to the coordinates (Xp, Yp).

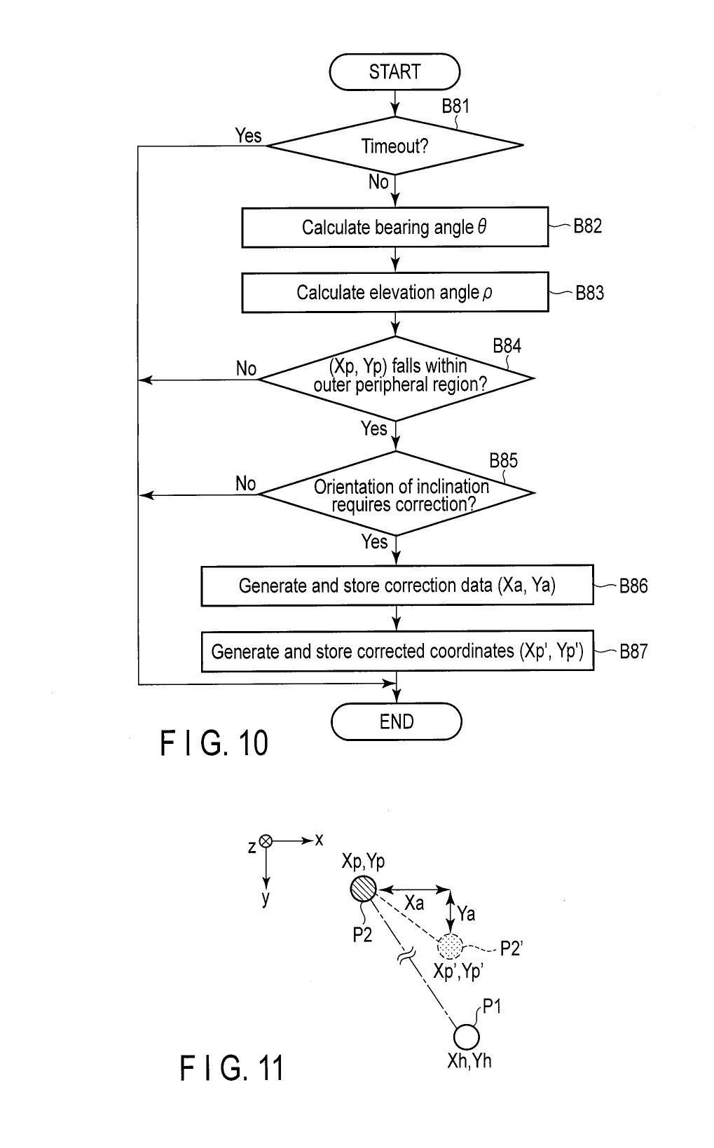

Subsequently, a method example of generating the corrected coordinates (Xp′, Yp′) in block B87 will be described referring to the model of FIG. 11. This model shows the relationship between the first position P1, the second position P2 and the corrected position P2,′ assumed when the detection surface 30 is seen along the Z axis.

As is evident from FIG. 11, the corrected coordinate Xp′ is obtained by adding the coordinate Xp and correction data Xa, and the corrected coordinate Yp′ is obtained by adding the coordinate Yp and correction data Ya. The signal processor 8 generates the corrected coordinates (Xp′, Yp′) by the addition in block B87.

Referring back to the flowchart of FIG. 9, the signal processor 8 generates position data in block B9 after the position correction processing of block B8. If the corrected coordinates (Xp′, Yp′) are already calculated in the position correction processing of the current loop, the position data includes the corrected coordinates (Xp′, Yp′) stored in the memory 80 in block B87 of the current loop, and the pen-pressure data stored in the memory 80 in block B84 of the current loop. In contrast, if the corrected coordinates (Xp′, Yp′) are not calculated in the position correction processing of the current loop, the position data includes the coordinates (Xp, Yp) and the pen-pressure data stored in the memory 80 in block B84 of the current loop.

The signal processor 8 sends the position data generated in block B9 to the system controller 20 (block B10). At this block B10, the signal processor 8 terminates the processing of the FIG. 9 flowchart.

By iterating the processing of the FIG. 9 flowchart, position data is periodically output from the signal processor 8 to the system controller 20 during the time when the input function using the digitizer is kept ON. Based on these position data items, the system controller 20 executes various types of processing. For instance, the system controller 20 causes the LCD panel 5 to display a pointer indicating the coordinates indicated by position data, or a line connecting the coordinates indicated by sequentially input position data items.

As described above, the electronic apparatus 1 of the embodiment corrects the coordinates (Xp, Yp), indicated on the detection surface 30 by the indicator 10, in accordance with the orientation of inclination of the indicator 10. Accordingly, even when the indicator 10 is used, inclined, input of an accurate position is possible.

Further, the electronic apparatus 1 of the embodiment determines the orientation of inclination of the indicator 10, based on the first position P1 (Xh, Yh) detected by the touch panel 4, and the second position P2 (Xp, Yp) detected by the sensor board 6. Namely, the electronic apparatus 1 or indicator 10 does not require any special device for determining the orientation of inclination of the indicator 10. Therefore, the electronic apparatus 1 can be reduced in thickness or in cost.

Furthermore, the electronic apparatus 1 of the embodiment executes the above-described correction on the outer peripheral region 31 in which the above-mentioned deviation will easily occur, and does not execute the correction on the central region 32. By thus limiting the correction target region, the processing load for correction can be reduced.

In addition, the electronic apparatus 1 of the embodiment does not correct the coordinates (Xp, Yp) if the time elapsing from the detection of the coordinates (Xh, Yh) exceeds Te. This prevents degradation of correction accuracy.

### Modifications

Various modifications will be described.

The above-described embodiment employs a tablet terminal as the electronic apparatus 1. However, the same structure as the above is also applicable to another type of electronic apparatus, such as a notebook PC or a smartphone.

In the above-described embodiment, the coordinates (Xp, Yp) are corrected using the bearing angle θ and the elevation angle ρ. However, the correction may be performed using the bearing angle θ or the elevation angle ρ.

In the above-described embodiment, the above correction is performed only when the coordinates (Xp, Yp) exist in the outer peripheral region 31 of the detection surface 30. However, the correction may be performed over the entire detection surface 30.

In the above-described embodiment, the correction data (Xa, Ya) is generated using functions FX (θ, ρ) and FY (θ, ρ). However, the correction data (Xa, Ya) may be generated by other methods. For instance, the correction data (Xa, Ya) may be acquired from a predetermined table. In this table, correction data (Xa, Ya) is set for, for example, each range of the bearing angle θ and the elevation angle ρ. Such tables may be prepared for the respective sides of the detection surface 30, and the correction data (Xa, Ya) be calculated, using the table corresponding to the side that is closest to the coordinates (Xp, Yp).

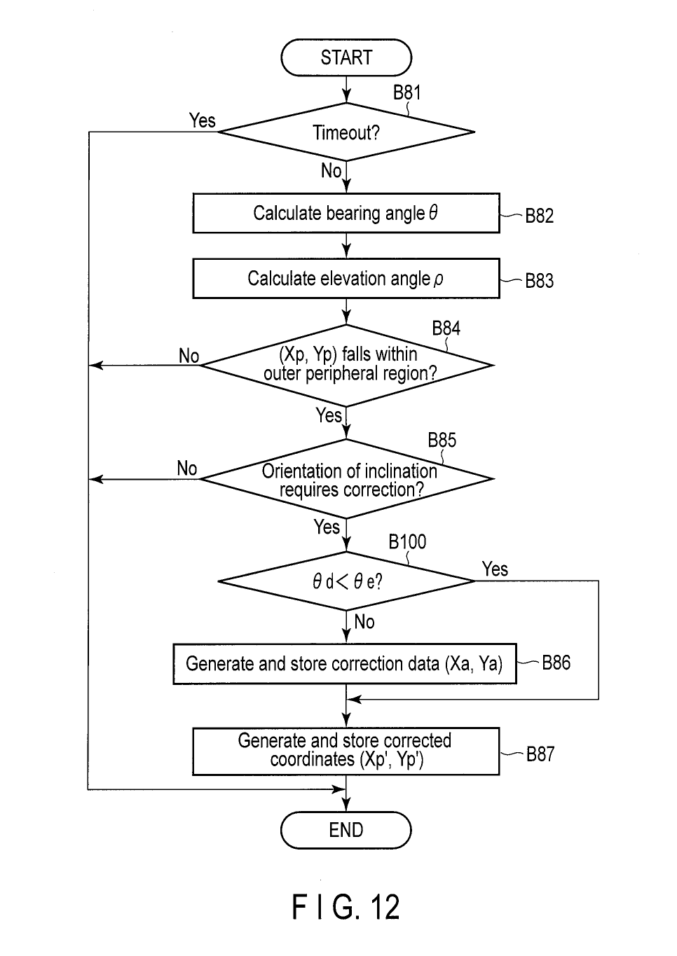

When the user inputs a position using the indicator 10, if variation in the orientation of inclination of the indictor 10 is small, the coordinates (Xp, Yp) sequentially detected may be corrected using the same correction data (Xa, Ya). Referring last to FIG. 12, this modification will be described.

FIG. 12 is a flowchart of position correction processing according to the above modification. This flowchart differs from the flowchart of FIG. 9 in that the former additionally employs block B100. The signal processor 8 determines after block B85 whether a difference θd is less than a threshold θe (block B100). The difference θd is the difference (|θ1−θ0|) between the bearing angle θ1 (a first orientation of inclination) calculated in block B82 of the current position correction processing, and the bearing angle θ0 (a second orientation of inclination) used to generate the correction data (Xa, Ya) that was used for correction in the last position correction processing. The threshold θe discriminates the case where recalculation of the correction data (Xa, Ya) is needed, from the case where no such recalculation is needed. The threshold θe is, for example, 30 degrees.

If the difference θd is not less than the threshold θe (No in block B100), the signal processor 8 generates correction data (Xa, Ya) as in the above embodiment (block B86), and corrects the coordinates (Xp, Yp) using the generated correction data (Xa, Ya) (block B87).

In contrast, if the difference θd is less than the threshold θe (Yes in block B100), the signal processor 8 skips block B86 and executes block B87. In block B87, the signal processor 8 corrects the coordinates (Xp, Yp) using the correction data (Xa, Ya) that was used in the last position correction processing.

Although in the modification, it is determined based on the difference associated with the bearing angle θ whether the correction data (Xa, Ya) should be generated, this may be determined based on the difference associated with the elevation angle ρ. Yet alternatively, based on both the differences associated with the bearing angle θ and the elevation angle ρ, whether the correction data (Xa, Ya) should be generated may be determined.

To sum up the modification, the signal processor 8 is configured to correct second coordinates (Xp, Yp) using the correction data (Xa, Ya) generated based on the second orientation (θ1) of inclination determined based on third coordinates (Xp, Yp) of a third position (P2) detected by the second detector before the second position (P2), when a difference between the first orientation of inclination (θ0) and the second orientation of inclination (θ1) is less than the first threshold (θe).

In the above-described embodiment and the modification described referring to FIG. 12, the signal processor 8 serves as the determination module 81 and the correction module 82. Alternatively, the functions of the determination module 81 and the correction module 82 may be realized by the system controller 20. Yet alternatively, ICs having functions as the determination module 81 and the correction module 82 may be provided in addition to the signal processor 8 and the system controller 20.

The computer programs for realizing the determination module 81 and the correction module 82 may be provided by beforehand installing them in the electronic apparatus, or by recording them in a computer-readable recording medium. Alternatively, the computer programs may be downloaded to the electronic apparatus via a network.

The orders of processing associated with blocks B1 to B10, B81 to B87 and B100 are not always limited to those shown in the flowcharts of FIGS. 9, 10 and 12. The orders may be changed arbitrarily.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a first detector configured to detect a first position on a detection surface;
a second detector configured to detect a second position indicated by an indicator on the detection surface;
a processor configured to determine a first orientation of inclination of the indicator based on first coordinates of the first position on the detection surface and second coordinates of the second position on the detection surface, and to correct the second coordinates based on the first orientation of inclination.

2. The electronic apparatus of claim 1, wherein the first orientation of inclination includes at least one of a bearing angle and an elevation angle, the bearing angle indicative of an inclination of the indicator with respect to a reference orientation in a plane parallel to the detection surface, the elevation angle indicative of an inclination of the indicator with respect to the detection surface.

3. The electronic apparatus of claim 1, wherein the processor is configured to correct the second coordinates based on the first orientation of inclination when the second coordinates belong to an outer peripheral region of the detection surface.

4. The electronic apparatus of claim 1, wherein the processor is configured not to correct the second coordinates when a first period of time has elapsed since the first detector detected the first position.

5. The electronic apparatus of claim 1, wherein the processor is configured to generate correction data for correcting the second coordinates, based on the first orientation of inclination, and to correct the second coordinates using the correction data.

6. The electronic apparatus of claim 5, wherein the processor is configured to correct the second coordinates using the correction data generated based on a second orientation of inclination determined based on third coordinates of a third position detected by the second detector before the second position, when a difference between the first orientation of inclination and the second orientation of inclination is less than a first threshold.

7. A coordinate correcting method comprising:
detecting a first position touched on a detection surface;
detecting a second position indicated by an indicator on the detection surface;
determining a first orientation of inclination of the indicator based on first coordinates of the first position on the detection surface and second coordinates of the second position on the detection surface; and
correcting the second coordinates based on the first orientation of inclination.

8. The coordinate correcting method of claim 7, wherein the first orientation of inclination includes at least one of a bearing angle and an elevation angle, the bearing angle indicative of an inclination of the indicator with respect to a reference orientation in a plane parallel to the detection surface, the elevation angle indicative of an inclination of the indicator with respect to the detection surface.

9. The coordinate correcting method of claim 7, wherein the correcting includes correcting the second coordinates based on the first orientation of inclination when the second coordinates belong to an outer peripheral region of the detection surface.

10. The coordinate correcting method of claim 7, wherein the second coordinates are not corrected when a first period of time has elapsed since the first position was detected.

11. The coordinate correcting method of claim 7, wherein the correcting includes generating correction data for correcting the second coordinates based on the first orientation of inclination, and correcting the second coordinates using the correction data.

12. The coordinate correcting method of claim 11, wherein the correcting includes correcting the second coordinates using the correction data generated based on a second orientation of inclination determined based on third coordinates of a third position detected before the second position, when a difference between the first orientation of inclination and the second orientation of inclination is less than a first threshold.
